(19) United States
(12) Patent Application Publication
(10) Pub. No.: US 2011/0048768 A1
(43) Pub. Date: Mar. 3, 2011

(54) POWER CABLE

(75) Inventors: Jonathan Catchpole, Oxfordshire (GB); David John Porter, Wiltshire (GB); Stewart Toplis, Wiltshire (GB)

(73) Assignee: Tyco Electronics UK Ltd., Wiltshire (GB)

(21) Appl. No.: 12/736,683

(22) PCT Filed: Apr. 2, 2009
(86) PCT No.: PCT/GB2009/050324

§ 371 Date: Oct. 29, 2010

(30) Foreign Application Priority Data
Apr. 29, 2008 (GB) 0807741.1

(51) Int. Cl. H01B 7/18

(52) U.S. Cl. 174/120 R

(57) ABSTRACT

A power cable (10) is disclosed comprising a metal conductor encased in a first outer sheath (11), and further encased, partially along the length of the cable, in a second outer sheath (12, 13, 14) which influences the pattern of deformation of the cable under mechanical stress.

### FIELD OF INVENTION

This invention relates to a power cable.

### SUMMARY OF INVENTION

In accordance with the present invention, there is provided a power cable comprising a metal conductor encased in a first outer sheath, and further encased, partially along the length of the cable, in a second outer sheath which influences the pattern of deformation of the cable under mechanical stress.

The first and second outer sheaths may be heat shrink tubing.

The second outer sheath may be located in the middle of the cable, at both ends of the cable or, in three distinct sections, in the middle and at both ends of the cable.

### BRIEF DESCRIPTION OF DRAWINGS

The invention will now be described, by way of example only, with reference to the following figures in which:

FIGS. 1a and 1b are 3-D and plan views respectively of a high voltage, high power jumper cable according to the present invention.

### DETAILED DESCRIPTION

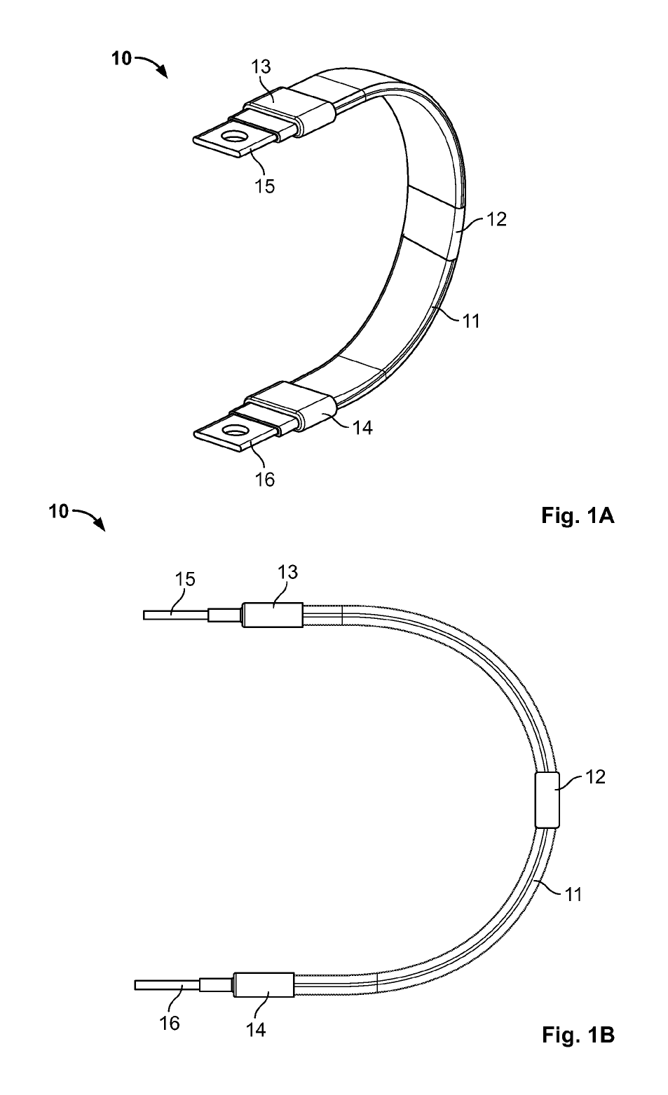

Referring to FIGS. 1a and 1b, a jumper cable 10 is shown comprising two terminals 15, 16 connected by a conducting tin coated, copper braid (not shown) which is entirely encases in a first layer of heat shrink tubing 11.

In accordance with the present invention, a second layer of heat shrink tubing 12, 13, 14 is applied over the first layer of heat shrink tubing in three locations; a first part 12 at the centre of the conducting cable, and second 13 and third 14 parts adjacent the terminals 15, 16.

In use, the second layer of heat shrink tubing 12, 13, 14 provides additional support of the conducting braid, and the selective application of the second layer of heat shrink tubing on the first layer of heat shrink tubing 11 influences the pattern of deformation of the cable 10 under mechanical. I.e. there is less deformation in such regions.

Although the embodiment description provides the second layer of heat shrink tubing 12, 13, 14 in three locations of the jumper cable 10, other configurations are contemplated.

1-6. (canceled)

7. A power cable comprising a metal conductor encased in a first outer sheath, and further encased, partially along the length of the cable, in a second outer sheath which influences the pattern of deformation of the cable under mechanical stress.

8. A cable according to claim 1, wherein the first outer sheath is heat shrink tubing.

9. A cable according to claim 1, wherein the second outer sheath is heat shrink tubing.

10. A cable according to claim 1, wherein the second outer sheath is located in the middle of the cable.

11. A cable according to claim 1, wherein the second outer sheath is located at both ends of the cable.

12. A cable according to claim 1, wherein the second outer sheath is located in three distinct sections in the middle and at both ends of the cable.
